(19) United States
(12) Patent Application Publication
(10) Pub. No.: US 2008/0083450 A1
(43) Pub. Date: Apr. 10, 2008

(54) Thermal management of concentrator photovoltaic cells

(75) Inventors: Jeffrey T. Benoit, Willington, CT (US); Thomas H. Vanderspurt, Glastonbury, CT (US); Jean Yamanis, South Glastonbury, CT (US); Rakesh Radhakrishnan, Vernon, CT (US); Satyam Bendapudi, Manchester, CT (US); Yirong Jiang, Manchester, CT (US); John Smeggil, Simsbury, CT (US); Albert T. Pucino, Glastonbury, CT (US); Wayde R. Schmidt, Pomfret Center, CT (US); Yu Chen, East Hartford, CT (US); Thomas D. Radcliff, Vernon, CT (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: United Technologies Corporation, Hartford, CT (US)

(21) Appl. No.: 11/542,968

(22) Filed: Oct. 4, 2006

(51) Int. Cl. H02N 6/00

(52) U.S. Cl. 136/246

(57) ABSTRACT

A concentrated solar energy system includes a photovoltaic cell, an optical concentrator, a heat removal system, and means for providing thermal contact between the photovoltaic cell and the heat removal system. The optical concentrator is configured to direct concentrated solar energy to the photovoltaic cell such that the photovoltaic cell generates electricity and heat. The heat removal system removes heat from the photovoltaic cell. The means for providing thermal contact provides an effective thermal conductivity per unit length between the photovoltaic cell and the heat removal system of greater than about 50 kilowatts per square meter per degree Celsius.

### BACKGROUND OF THE INVENTION

Solar cells, or photovoltaic cells, have the ability to convert sunlight directly into electricity. Current technology produces solar cells that are approximately 15 percent efficient in converting absorbed light into electricity. Concentrator photovoltaic cells, that is, photovoltaic cells coupled to sunlight concentrator optics, capture more of the electromagnetic spectrum and are more efficient, converting absorbed light into electricity at about 30 percent efficiency. Simultaneously, about 70 percent of the solar energy is converted to heat. Due to the small size of the photovoltaic cells and the high-energy absorption, the heat must be efficiently dissipated from the cell to the environment to prevent degradation of performance or damage of the cells. If properly collected, the dissipated heat may be beneficially used to heat structures or drive heat-enabled processes.

### BRIEF SUMMARY OF THE INVENTION

In an exemplary embodiment, a concentrated solar energy system includes a photovoltaic cell, an optical concentrator configured to direct concentrated solar energy to the photovoltaic cell such that the photovoltaic cell generates electricity and heat, a heat removal system for removing heat from the photovoltaic cell, and means for providing thermal contact between the photovoltaic cell and the heat removal system. The means for providing thermal contact provides an effective thermal conductivity per unit length between the photovoltaic cell and the heat removal system of greater than about 50 kilowatts per square meter per degree Celsius.

In another exemplary embodiment, a solar cell system includes a solar cell, a heat removal system, and an interface structure positioned between the solar cell and the heat removal system. The solar cell generates electrical energy and heat. The heat removal system dissipates the heat from the solar cell with the interface structure transferring the heat from the solar cell to the heat removal system. At least 75 percent of the heat generated by the solar cell is transferred to the heat removal system.

In yet another exemplary embodiment, a method of removing heat from a photovoltaic cell includes positioning a heat removal system proximate the photovoltaic cell and providing thermal contact between the photovolatic cell and the heat removal system. At least 75 percent of the heat from the photovoltaic cell is transferred to the heat removal system.

### BRIEF DESCRIPTION OF THE DRAWING

FIG. 1 is a side view of a representative embodiment of a thermal management system.

FIG. 2A is a top view of an exemplary embodiment of the thermal management system.

FIG. 2B is a side view of the exemplary embodiment of the thermal management system along plane A-A in FIG. 2A.

FIG. 3A is a top view of an exemplary embodiment of the thermal management system.

FIG. 3B is a side view of the exemplary embodiment of the thermal management system along plane B-B in FIG. 3A.

FIG. 4A is a top view of an exemplary embodiment of the thermal management system.

FIG. 4B is a side view of the exemplary embodiment of the thermal management system along plane C-C in FIG. 4A.

FIG. 5 is an exemplary embodiment of the thermal management system.

FIG. 6 is an exemplary embodiment of the thermal management system.

FIG. 7A is an exemplary embodiment of the thermal management system.

FIG. 7B is an exemplary embodiment of the thermal management system.

FIG. 7C is an exemplary embodiment of the thermal management system.

FIG. 7D is an exemplary embodiment of the thermal management system.

### DETAILED DESCRIPTION

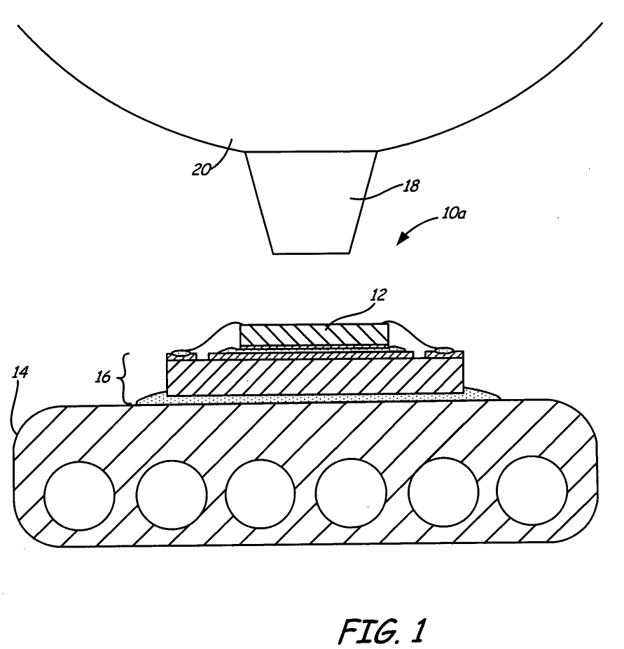

FIG. 1 shows a side view of a representative embodiment of thermal management system 10 that thermally manages the temperature of a solar cell system. Thermal management system 10 includes concentrator photovoltaic (CPV) cell 12 and heat removal system 14. Photovoltaic cell 12 may be made of a single junction high efficiency photovoltaic cell or a multiple-junction high efficiency photovoltaic cell. The concentration factor of solar energy through photovoltaic cell 12 may be any number higher than unity, preferably higher than 100, and more preferably higher than 500.

Thermal management system 10 provides enhanced thermal contact between CPV cell 12 and heat removal system 14 by minimizing the thermal resistance across interface structure 16, and by minimizing the effects of thermal mismatch between CPV cell 12 and heat removal system 14 to ensure robustness under thermal cycling. Thermal management system 10 preferably functions to facilitate electrical insulation of CPV cell 12 from heat removal system 14 while providing sufficient thermal conductivity and/or minimizing individual layer thickness to ensure adequate heat removal from CPV cell 12. This maintains the temperature of CPV cell 12 within its specified operating limits. Thermal management system 10 also acts to deliver the maximum amount of heat energy to heat removal system 14 for possible use in heat utilization elements such as, for example, domestic hot water systems or absorption chillers.

CPV cell 12 is positioned directly beneath optical concentrator 20. Optical concentrator 20 is aligned with respect to the sun so that it optimally collects and focuses a maximum amount of solar energy for the dimensions of CPV cell 12. Optical concentrator 20 includes one or more optical elements for the purpose of collecting and concentrating the solar energy and providing this energy to CPV cell 12. Optical elements of optical concentrator 20 may include, but are not limited to, one or more of the following in various combinations: mirrors, lenses, fresnel lenses, prisms, and optical fibers. Optical concentrator 20 may optionally include tertiary optics 18 that refract and further direct light to CPV cell 12, with a portion of the internally glancing rays reflected internally off of the side walls of tertiary optics 18 to CPV cell 12. The solar energy is then absorbed into CPV cell 12 and a portion of the solar energy is subsequently converted into electrical energy. The fraction of solar energy that is not converted into electricity turns into heat. It will be appreciated that because CPV cell 12 is between approximately 10% and approximately 40% efficient, between approximately 60% and approximately 90% of the energy absorbed by CPV cell 12 is correspondingly converted to heat. The heat must be dissipated from CPV cell 12 to prevent damage and decreased performance of CPV cell 12. Optionally, the dissipated heat may be recovered and used as thermal energy to beneficially drive other processes. Although FIG. 1 is discussed with optical concentrator 20 including tertiary optics 18, optical concentrator 20 may optionally function without the use of tertiary optics.

The methods of thermally managing CPV cell 12 disclosed herein are particularly effective when heat removal system 14 is a heat sink formed of a thermally conductive material, such as aluminum or copper.

Thermal management system 10 includes an interface structure 16 that is positioned between CPV cell 12 and heat removal system 14 and is used to thermally manage the temperature of CPV cell 12 in a concentrating environment. Interface structure 16 is formed of thermally conductive layers, some of which are electrically insulating and some of which are electrically conductive, that align and attach heat removal system 14 with CPV cell 12 in order to prevent overheating of CPV cell 12 and to increase the rate of heat transfer from CPV cell 12 to heat removal system 14. This attachment is most reliably accomplished by minimizing the difference in the coefficients of thermal expansion in the layers of CPV cell 12, heat removal system 14, and interface structure 16. Large differences between the coefficients of thermal expansion of CPV cell 12, heat removal system 14, and interface structure 16 make CPV cell 12 susceptible to cracking or fracture due to thermally induced stress. Interface structure 16 must therefore minimize the difference in the coefficients of thermal expansion between the layers and provide sufficient thermal conductivity to pass heat from CPV cell 12 to heat removal system 14 such that CPV cell 12 stays within its specified operating limits.

An exemplary embodiment of sufficient thermal conductivity from CPV cell 12 to heat removal system 14 is an effective thermal conductivity per unit length between CPV cell 12 and heat removal system 14 of greater than approximately 50 kilowatts per square meter per degree Celsius (kW/m²/° C.). In another exemplary embodiment, sufficient thermal conductivity from CPV cell 12 to heat removal system 14 is an effective thermal conductivity per unit length between CPV cell 12 and heat removal system 14 of greater than approximately 100 kW/m²/° C. In yet another exemplary embodiment, sufficient thermal conductivity from CPV cell 12 to heat removal system 14 is an effective thermal conductivity per unit length between CPV cell 12 and heat removal system 14 of greater than approximately 200 kW/m²/° C. In yet another exemplary embodiment, sufficient thermal conductivity from CPV cell 12 to heat removal system 14 is an effective thermal conductivity per unit length between CPV cell 12 and heat removal system 14 of greater than approximately 300 kW/m²/° C. While specific thermal conductivities per unit length between CPV cell 12 and heat removal system 14 are given, it will be apparent to one skilled in the art that any thermal conductivities per unit length between 50 kW/m²/° C. and 300 kW/m²/° C. is acceptable.

For a thermal flux of approximately 500 kilowatts per square meter, the effective thermal conductivity per unit length of 50 kW/m²/° C. will yield a temperature difference between CPV cell 12 and heat removal system 14 of approximately 10 degrees C. (° C.). For a thermal flux of approximately 500 kilowatts per square meter and an effective thermal conductivity per unit length between CPV cell 12 and heat removal system 14 of greater than approximately 300 kW/m²/° C., there is an effective temperature difference between CPV cell 12 and heat removal system 14 of less than approximately 2° C. Another exemplary embodiment of sufficient thermal conductivity from CPV cell 12 to heat removal system 14 is when at least 75% of the heat generated by CPV cell 12 is transferred to heat removal system 14. More particularly, there is sufficient thermal conductivity from CPV cell 12 to heat removal system 14 when at least 90% of the heat generated by CPV cell 12 is transferred to heat removal system 14.

Interface structure 16 must also provide mechanical holding strength in order to maintain the physical attachment and thermal contact of CPV cell 12 to heat removal system 14. In some embodiments, heat removal system 14 is maintained in position relative to optical concentrator 20 by other structures (not shown). In these cases, maintaining the position of CPV cell 12 relative to heat removal system 14 will also maintain the needed alignment of CPV cell 12 relative to optical concentrator 20.

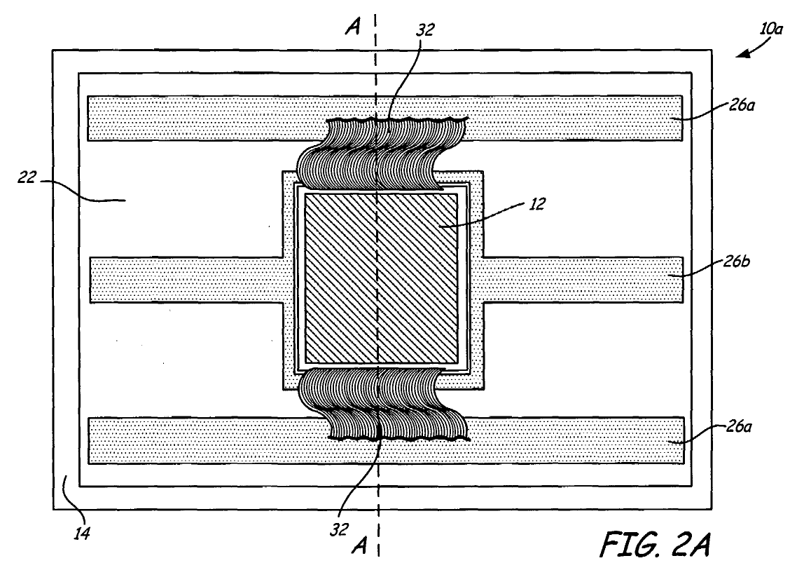

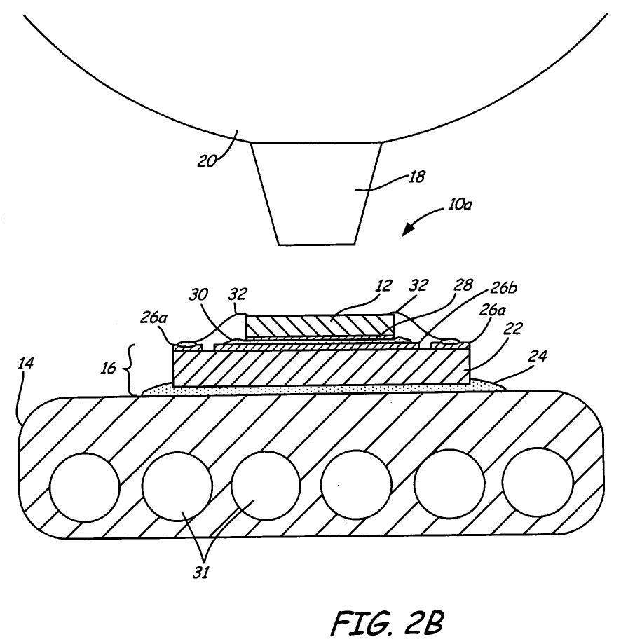

FIGS. 2A and 2B show a top view and a side view, respectively, of an exemplary embodiment of thermal management system 10a. In thermal management system 10a, interface structure 16 is formed of an aluminum nitride (AlN) substrate layer 22, a thermally conductive bonding material layer 24, electrically conductive patterned metal layers 26a and 26b positioned above AlN substrate layer 22, backside metal layer 28, and bonding material 30. Patterned metal layers 26a and 26b facilitate electrical connection of the two different electrical potentials of CPV cell 12 to other CPV cells and eventually to other electrical circuits, as well as an electrical load.

Heat removal system 14 contacts interface structure 16 and either passively or actively dissipates heat from CPV cell 12. Passive dissipation of heat involves no forced fluid flow past or through heat removal system 14, whereas active dissipation of heat involves forced fluid flow past or through heat removal system 14. In order to ensure high heat transfer from CPV cell 12 to heat removal system 14, interface structure 16 acts to provide increased thermal contact between heat removal system 14 and CPV cell 12. The heat removed from CPV cell 12 may subsequently either be dissipated into the environment or recovered and transported for use in an adjoining process system that is heat driven. Heat removal system 14 may include, but is not limited to: a heat sink, a heat spreader, or a heat exchanger having fluid passages 31 through which a heat transfer fluid is circulated to efficiently remove heat and maintain the temperature of CPV cell 12 within specified bounds. The heat removed by the fluid circulating through passages 27 and heat removal system 14 may be beneficially used to heat a building space or to drive a process that employs heat.

As mentioned above, in an exemplary embodiment, thermal management system 10a includes aluminum nitride (AlN) substrate layer 22 as a part of interface structure 16. AlN substrate layer 22 is connected to heat removal system 14 by bonding material layer 24, which is thermally conductive and may be either electrically insulating or electrically conducting. The purpose of AlN substrate layer 22 is to electrically insulate CPV cell 12 from heat removal system 14 while also physically holding the position of CPV cell 12 relative to heat removal system 14 and providing a high thermal conductivity path from CPV cell 12 to heat removal system 14. The purpose of bonding material layer 24 is to provide mechanical and thermal attachment of AlN substrate layer 22 to heat removal system 14. Bonding material layer 24 may be comprised of any suitable material, including, but not limited to: a high thermal conductivity epoxy, thermoplastic resin, glass, or solder. Exemplary embodiments of layer thicknesses for AlN substrate layer 22 and: bonding material layer 24 are approximately 0.1 millimeters (mm) for bonding material layer 24 and bonding material 30, between approximately 0.6 mm and approximately 1.0 mm for AlN substrate layer 22, and between approximately 0.01 mm and approximately 0.1 mm for patterned metal layers 26a and 26b.

AlN substrate layer 22 may also be made of other electrically insulating materials such as ceramic, glass, epoxy, polyimide, plastic, or the like. As shown in FIGS. 2A and 2B, patterned metal layers 26a and 26b are deposited and patterned on AlN substrate layer 22 and form direct current (DC) electrical connections for CPV cell 12. These DC electrical connections enable electrical interconnection between a multitude of CPV cells 12 and eventually to electrical circuitry and an external electric load. Examples of patterned metal layers 26a and 26b include, but are not limited to: thick film metal, direct bond copper (DBC), and thin film metal.

A suitable CPV die backside metal layer 28, such as gold, is deposited on the backside of CPV cell 12 as employed in semiconductor die processing. Backside metal layer 28 provides increased thermal conductivity and improved solder wetting capability to enable die attach of CPV cell 12 to patterned metal layer 26b using solder for bonding material 30. Electrically conductive epoxy, or other suitable die attach adhesive may also be used as bonding material 30. CPV cell 12 with backside metal layer 28 is positioned on top of bonding material 30 to provide a mechanical connection of CPV cell 12 to the rest of the structure as well as the needed backside electrical contact to CPV cell 12. CPV cell 12 is positioned on top of bonding material 30. Patterned metal layers 26a and 26b are positioned on AlN substrate layer 22 and may provide the means for electrical connection of CPV cell 12 to other CPV cells.

Examples of patterned metal layers 26a and 26b include, but are not limited to: thick film metal, thin film metal, and direct bond copper (DBC). The thick film metal may be deposited onto AlN substrate layer 22 to make a continuous conductive material by any suitable method known in the art, including, but not limited to: screen-printing in paste form and pattern dispensing with a syringe and subsequently drying to remove solvents and heat treating to sinter metal particles. The thin film metal may be deposited onto AlN substrate layer 22 by any suitable method known in the art, including, but not limited to: sputter deposition, metal vapor deposition, and chemical vapor deposition. Thin film metal layers may be deposited as a continuous layer and then patterned using photolithography and etching processes. DBC may be formed by oxidizing a copper sheet and then pressing it against a pre-oxidized AlN substrate layer 22 at a temperature of approximately 1070° C. At this temperature, the copper contains approximately 1.6 atomic percent oxygen at the interface that forms a eutectic copper-oxygen melt zone while the AlN substrate layer 22 and the copper remain solid. This melt zone chemically bonds to both the copper layer and AlN ceramic substrate layer 22, resulting in the direct bond copper metallization. This DBC may be etched to the desired pattern after bonding by suitable mask and etch techniques known in the art. Alternatively, the copper may be etched or stamped to the desired shape prior to the bonding process by suitable methods known in the art.

Wire bonds, beam leads, ribbon bonds, or flexible circuits 32 connect patterned metal layers 26a to CPV cell 12 and form electrical attachments to a top side of CPV cell 12. Wire bonds and beam leads may be formed of materials including, but not limited to: aluminum, gold, and copper. Wire bonds and beam leads may then be attached to CPV cell 12 and patterned metal layers 26a by ultrasonic or thermosonic metal-to-metal bonding methods. If the beam lead is formed of copper, the beam lead can be attached through soldering. Flexible circuits 32 may be formed of copper or other patterned metal that was previously attached to a flexible dielectric material, such as polyimide. Both ends of flexible circuit 32 have exposed bare metal so that flexible circuit 32 may be soldered to CPV cell 12 and patterned metal layers 26a. Also, as previously mentioned, CPV cell 12 may also have a backside electrical connection through backside metal layer 28 to conductive patterned metal layer 26b.

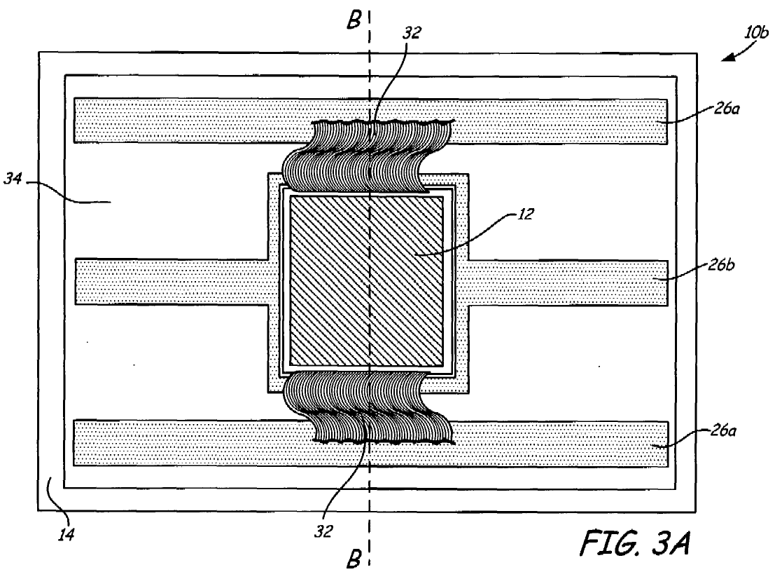

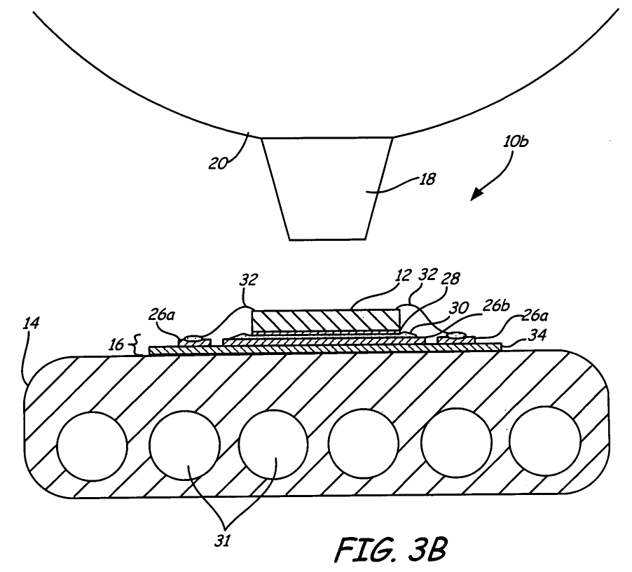

FIGS. 3A and 3B show a top view and a side view, respectively, of another exemplary embodiment of thermal management system 10b using thin dielectric layer 34 as part of interface structure 16 in place of AlN substrate layer 22 (shown in FIGS. 2A and 2B). In exemplary embodiments shown in FIGS. 3A and 3B, a very thin dielectric layer 34 may be formed on heat removal system 14 to reduce the complexity of interface structure 16 by eliminating the need for an AlN substrate layer 22 and bonding material layer 30 between CPV cell 12 and heat removal system 14. Thin dielectric layer 34 also decreases the thermal resistance from CPV cell 12 to heat removal system 14 by eliminating bonding material layer 30. In an exemplary embodiment, aluminum is employed as the heat removal material. For example, a thin oxide layer may be prepared that provides a dielectric layer that insulates CPV cell 12 from heat removal system 14. The dielectric layer may be produced by an anodizing process and may be a single anodized layer or a composite of one or more layers that provides adequate adhesive strength, adequate electrical isolation, resistance to micro-cracking and debonding, and resistance to corrosion. The anodized oxide layer is formed on heat removal system 14 such that it is sufficiently thick to provide electrical isolation of CPV cell 12 from heat removal system 14, yet thin enough so that it does not present significant resistance to heat flow. The anodized oxide layer may have a thickness ranging from between approximately 0.1 micrometers and approximately 50 micrometers. The anodized oxide layer may also be dyed to provide improved reflectance or absorbance of radiative energy, as needed.

Another exemplary embodiment of thin dielectric layer 34 is aluminum phosphate. The aluminum phosphate facilitates bonding between patterned metal layer 26b and heat removal system 14 and therefore provides increased adhesion of CPV cell 12 to heat removal system 14. The increased adhesion results in an improved rate of heat transfer between CPV cell 12 and heat removal system 14 by helping to minimize poor conductive voids in the bond between CPV cell 12 and heat removal system 14. By forming the dielectric layer containing aluminum directly on heat removal system 14, the need for a carrier substrate, such as AlN substrate layer 22 (shown in FIGS. 2A and 2B) for providing electrical isolation of CPV cell 12 from heat removal system 14 while minimizing thermal resistance between CPV cell 12 and heat removal system 14 is eliminated.

Other suitable examples of thin dielectric layers 34 include, but are not limited to: polyimide, polybenzyl imidizole, and mixtures thereof. Thin dielectric layer 34 may also act as a crack-resistant adhesive layer with appropriate functionalization of the monomer and addition of higher thermal conductivity, electrically insulating nano-fibrils.

Suitable nano-fibrils are formed of thermally stable materials, including, but not limited to: boron nitride, aluminum nitride, silicon carbide, and formulated polymer resins such as thermopolymers. Examples of thermopolymers include, but are not limited to: polyamide, polyamide-imides, polybenzyl imidazole, polyphthalamide, polyethylene naphthalate (PEN), polyamideimide, polyphenylene oxide, polysulfone, polyethersulfone, polyphenylene sulfide, polyetheretherketone (PEEK), polyetherimide, polyarylates, and appropriate mixtures, copolymers, and the like.

Additionally, patterned metal layers 26a and 26b on thin dielectric layer 34 may be used. Patterned metal layers 26a and 26b enable the electrical circuitry of CPV cell 12 that connects CPV cell 12 to other cells in series or parallel to obtain electricity from CPV cell 12, reducing material volume and cost. Conductive patterned metal layers 26a and 26b may include, but are not limited to: DBC, thick film metal, or thin film metal.

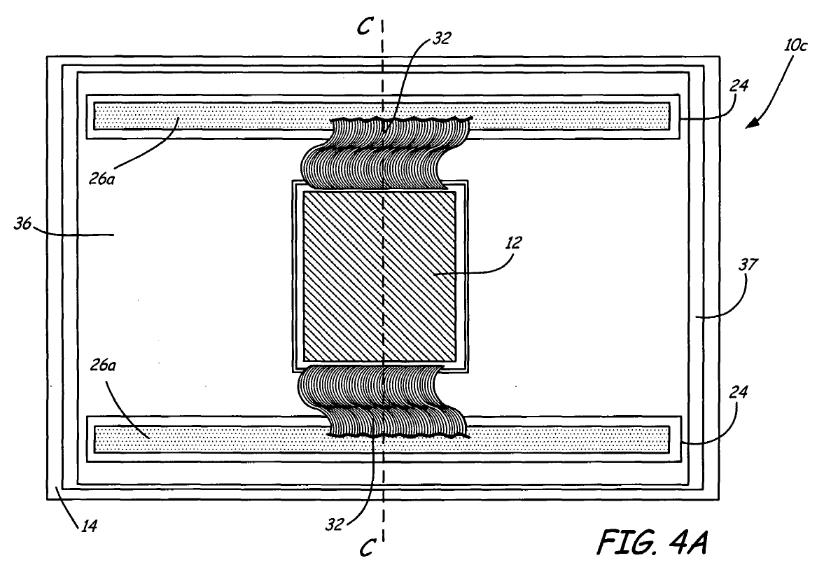

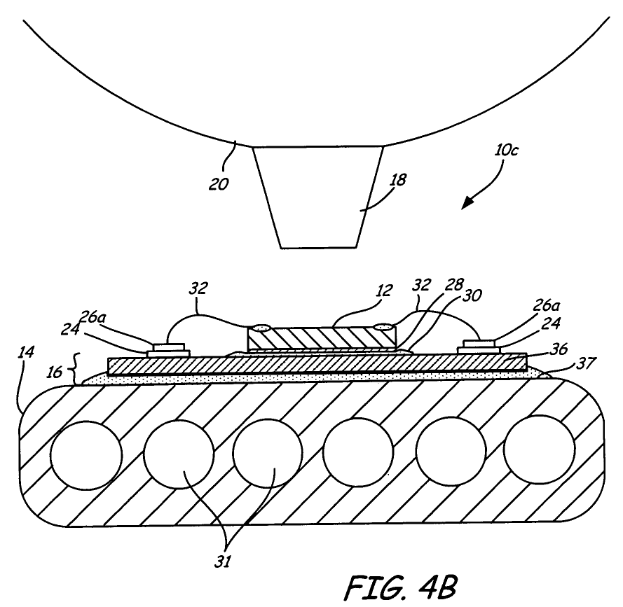

FIGS. 4A and 4B show a top view and a side view, respectively, of an exemplary embodiment of thermal management system 10c employing heat spreader 36 as part of interface structure 16. Heat spreader 36 is attached to heat removal system 14 and CPV cell 12 in the same manner as AlN substrate layer 22 is attached to heat removal system 14 and CPV cell 12, as described in the discussion of thermal management system 10a (shown in FIGS. 2A and 2B). The difference is that heat spreader 36 is attached to heat removal system 14 by dielectric adhesive 37. Dielectric adhesive 37 is any of a number of suitable electrically insulating, thermally conducting adhesives including, but not limited to: filled or unfilled epoxies, polyimides, and silicones. Heat spreader 36 is formed of metal, such as copper, and spreads the heat generated by CPV cell 12 laterally before the heat is transferred to heat removal system 14. The increased surface area provided by heat spreader 36 between CPV cell 12 and heat removal system 14 increases the rate of thermal transfer to heat removal system 14. Dielectric adhesive 37 has spacer particles that maintain electrical isolation between heat spreader 36 and heat removal system 14 while still minimizing thermal resistance. Thermal resistance of dielectric adhesive layer 37 is preferably reduced by maximizing its thermal conductivity and minimizing its thickness. The thickness of dielectric adhesive layer 37 may only be minimized to the thickness of the spacer particle dimensions in order to maintain the electrical isolation of heat spreader 36 and heat removal system 14. Minimizing the surface roughness of the proximate surfaces of heat spreader 36 and heat removal system 14 allows for reducing the spacer particle size, which helps to minimize the thermal resistance of dielectric adhesive layer 37.

In an exemplary embodiment of thermal management system 10c, the electrical connection of flexible circuits 32 from the top of CPV cell 12 to patterned metal layers 26a may be provided by wire bonds, beam leads, ribbon bonds, or flexible circuits. Patterned metal layers 26a are deposited on dielectric layer 24, which is deposited on top of heat spreader 36. Similar to thermal management system 10a shown in FIGS. 2A and 2B, examples of patterned metal layers 26a include, but are not limited to: direct bond copper, thick film metal, and thin film metal. Exemplary embodiments of thin dielectric layer 34 include, but are not limited to: a polyimide and a thick film dielectric.

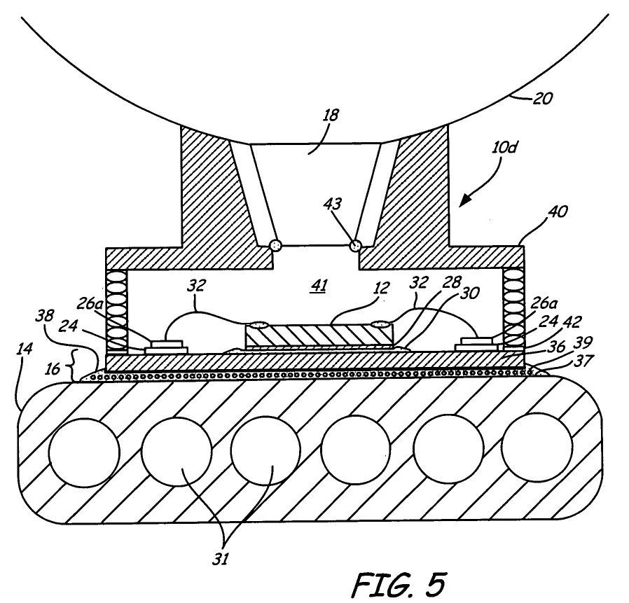

FIG. 5 shows another exemplary embodiment of thermal management system 10d with a layer of high boiling temperature thermal grease 38 filled with aluminum nitride (AlN) microspheres 39 acting as interface structure 16. Alternatively, microspheres 39 may be made from other electrically insulating high thermal conductivity materials such as, but not limited to: alumina and beryllium oxide. This interface structure 16 facilitates unconstrained lateral motion between CPV cell 12 as mounted on heat spreader 36 and heat removal system 14 while providing for thermal conductivity and electrical isolation between CPV cell 12 and heat removal system 14. Thermal management system 10d also uses a bellows assembly 40 filled with optical fluid 41 to transmit a hydraulic pressure between tertiary optics 18 of optical concentrator 20 and CPV cell 12, which also facilitates unobstructed transmission of light from tertiary optics 18 to CPV cell 12. The hydraulic pressure is provided by a downward pressure from optical concentrator 20 that is transmitted to CPV cell 12 through optical fluid 41. Optical fluid 14 is captive above CPV cell 12 and provides passage of concentrated solar energy through optical fluid 41 to CPV cell 12. Bellows assembly 40 is attached to heat removal system 14 through braze 42. Teflon seal 43 between bellows assembly 40 and tertiary optics 18 prevents leakage of optical fluid 41 out of bellows assembly 40. Optical concentrator 20 may optionally be directly interfaced to bellows assembly 40 by use of Teflon seal 43. In an exemplary embodiment, optical fluid 41 may be any of a variety of suitable optically transparent, thermally stable fluids, including, but not limited to, microscope immersion lens oil.

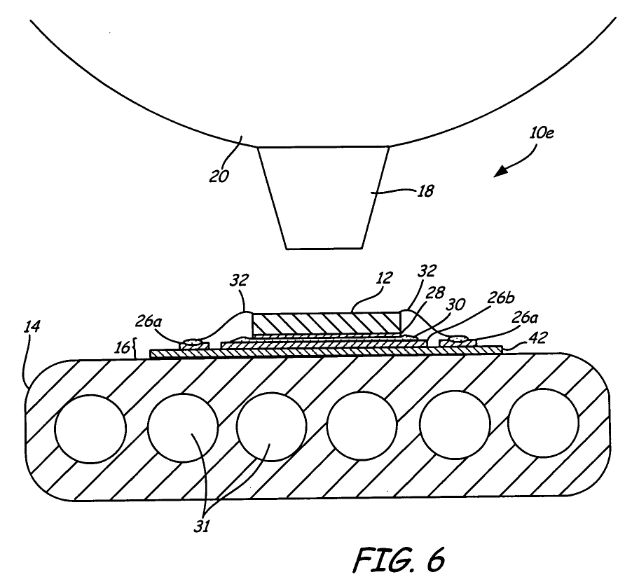

In another exemplary embodiment shown in FIG. 6, thermal management system 10e uses bonding material 30 having anisotropic stiffness in at least one direction as part of interface structure 16. Bonding material 30 minimizes the stress on CPV cell 12, provides electrical and thermal conduction to underlying layers of CPV cell 12, and provides some attachment between CPV cell 12 and heat removal system 14. The anisotropic stiffness of bonding material 30 relieves the mechanical stress from thermal expansion mismatches between CPV cell 12 and the underlying substrate or heat removal system 14. Additionally, if bonding material 30 is stiffer in the vertical direction than in the horizontal direction, the direction of heat flow from CPV cell 12 to heat removal system 14 can also potentially be controlled while allowing for lateral movement of CPV cell 12 relative to heat removal system 14 in order to relieve thermal-related stresses induced by relative dimensional changes. Suitable die attach materials include, but are not limited to: composite materials made up of matrix materials that include thermoset adhesives such as epoxies and polyimides and particulate filler materials such as, but not limited to: silver, silicon carbide, and graphite. Preferably, the materials and deposition methods are selected to provide anisotropic properties in bonding material 30.

Bonding material 30 may also include filler materials, including, but not limited to: silicon carbide and other metals, ceramics, and polymeric materials. If particulate filler materials are used, they may be of any single geometry including, but not limited to: spheres, rods, fibers, and other regular shapes, irregular shapes, or combinations of geometries. The composition and morphology of the filler(s) are chosen to control the thermal, mechanical, and electrical properties of bonding material 30. For example, if silicon carbide fibers are used, the fibers are preferably aligned parallel to the direction of desired heat flow so that the fibers can guide the heat flow in a direction parallel to the axis of the fiber. In compression, the incorporated silicon carbide fibers then act to stiffen the die attach material relative to a direction perpendicular to the axis of the orientation of the fibers.

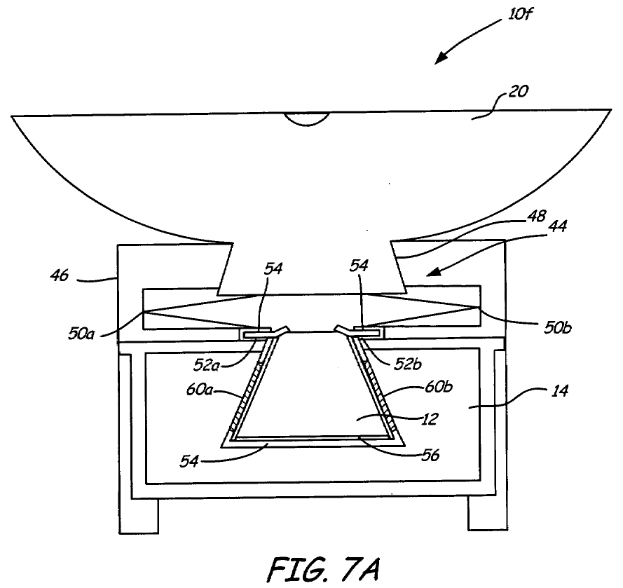

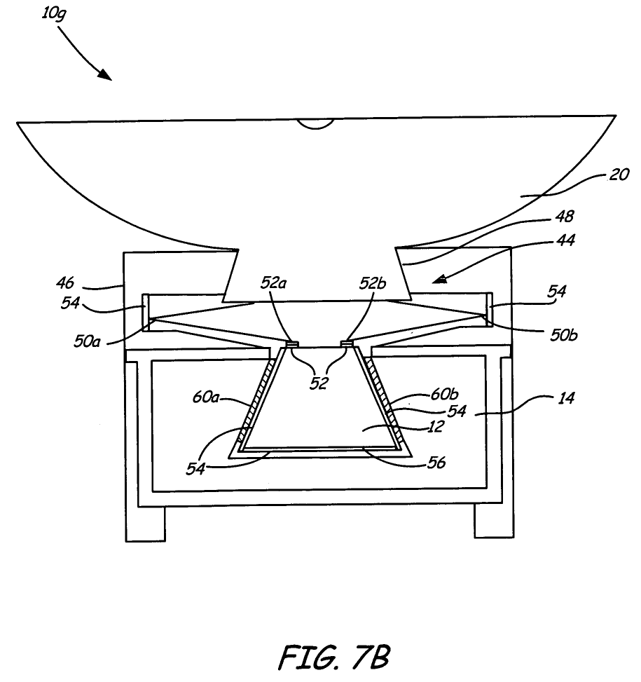

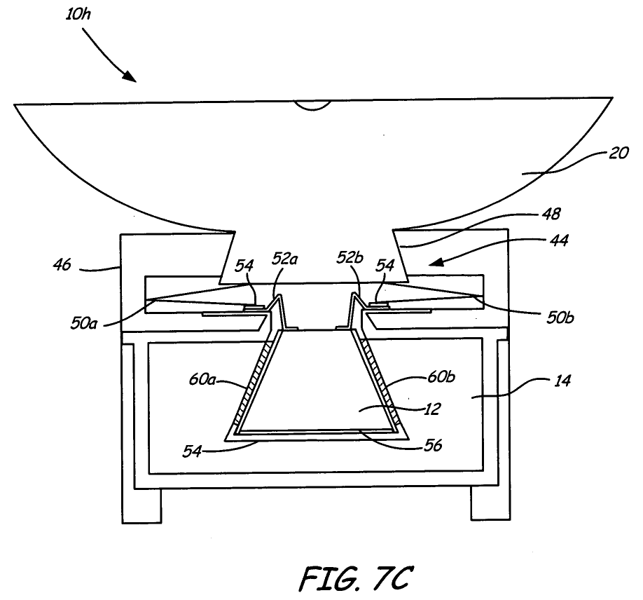

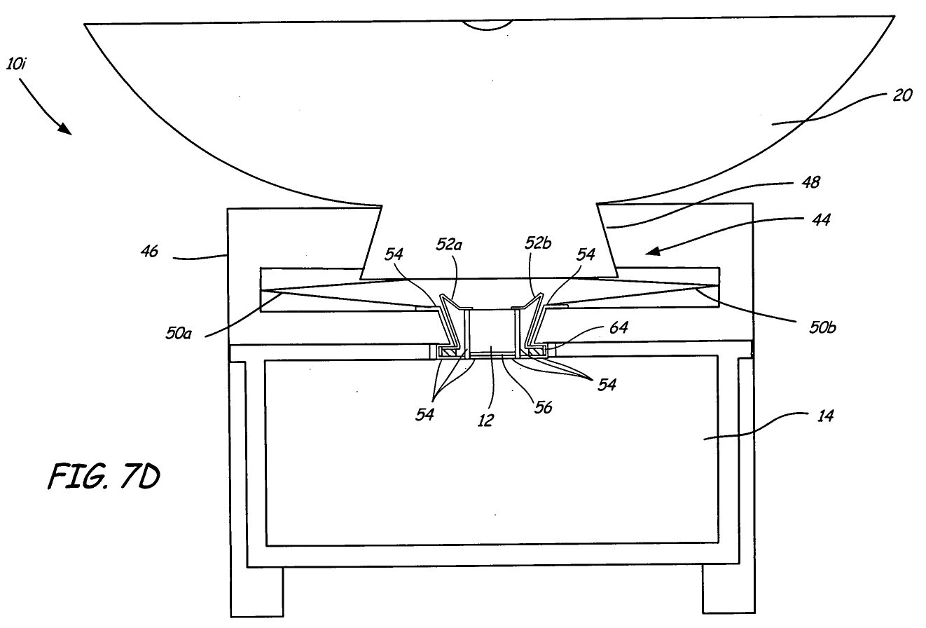

FIGS. 7A, 7B, 7C, and 7D show four configurations of exemplary embodiments of thermal management systems 10f, 10g, 10h, and 10i respectively. Thermal management systems 10f-10i use dovetail connection arrangement 44 in conjunction with support 46 to provide increased thermal contact between CPV cell 12 and heat removal system 14. Dovetail connection or attachment 44 is a joint at the bottom of optical concentrator 20 having a trapezoidal cross-section with the base of dovetail connection 44 being wider than the top of dovetail connection 44. Dovetail connection 44 sits within an aperture 48 of support 46 sized to prevent the base of dovetail connection 44 from slipping from support 46 once in place. A bottom edge of support 46 firmly engages the bottom of heat removal system 14, and along with springs 50a and 50b of support 46, hold optical concentrator 20 proximate CPV cell 12. In an exemplary embodiment, support 46 is formed of metal and insulating material is formed of AlN or aluminum oxide.

Thermal management systems 10f, 10g, and 10h are very similar to each other and will be discussed in conjunction with one another. The difference between thermal management systems 10f, 10g, and 10h is the configurations of clips 52a and 52b. Thermal management systems 10f, 10g, and 10h include a cavity 58 within heat removal system 14 in which CPV cell 12 is positioned. Cavity 58 includes a layer of thermally conducting, dielectric material 54 between CPV cell 12 and heat removal system 14. Springs 60a and 60b are positioned in cavity 58 between CPV cell 12 and heat removal system 14 and hold CPV cell 12 in firm contact with heat removal system 14.

As can be seen in FIGS. 7A, 7B, and 7C, clips 52a and 52b located between support springs 50a and 50b and heat removal system 14 hold CPV cell 12 down in firm contact with heat removal system 14. In addition, an electrically insulating, thermally conducting, dielectric material 54 is used in compression with clips 52a and 52b between springs 50a and 50b and support 46. A photovoltaic electrical connection 56 connects support 46 and CPV cell 12 and may also function as springs to hold support 46 against. CPV cell 12. Photovoltaic electrical connection 56 provides for the alignment of CPV cell 12 with heat removal system 14 and maintains CPV cell 12 in a stationary position.

Thermal management system 10i, shown in FIG. 7D, includes aperture 62 within heat removal device 14 where CPV cell 12 sits. Aperture 62 is sized to accept CPV cell 12. Clips 52a and 52b are positioned on both sides of aperture 62 to hold CPV cell 12 in place within heat removal system 14. Clips 52a and 52b are coated with thermally conducting, dielectric material 54 where they come into contact with support structure 46 or heat removal system 14, thus electrically isolating them and allowing them to be part of the electrical current collection system. As can be seen in FIG. 7D, clips 52a and 52b fit snugly between support structure 46 and heat removal system 14. Clips 52a and 52b are isolated from support structure 46 by thermally conducting, dielectric material 54 and are positioned on electrical connections 64. In the exemplary embodiments discussed above for thermal management systems 10f-10i, the sides of CPV cell 12 are coated with thermally conducting, dielectric material 54 to prevent CPV cell 12 from short circuiting.

Although the above exemplary embodiments are discussed independently of each other, in some cases the various embodiments may be used in combination with each other. In addition, other methods may also be used in combination with the embodiments previously mentioned. For example, the enclosed space above CPV cell 12 may be backfilled with an overpressure of inert gas. The inert gas prevents ambient ingress, condensation, and corrosion problems, which decrease the thermal contact between CPV cell 12 and heat removal system 14 as well as result in the potential loss of desired electrical connections, resulting in the loss of the electrical power output of CPV cell 12. Because backfilling the enclosed space above CPV cell 12 with inert gas increases the tolerance of the system to small leaks, backfilling CPV cell 12 is more effective than using a vacuum in this space.

In another exemplary embodiment, a metal collar may be positioned on tertiary optics 18. If the metal collar is also in contact with the electrical connection on the top surface of CPV cell 12, the metal collar will also provide an electrical contact to the top of CPV cell 12 in order to connect CPV cell 12 in series or in parallel with other cells as well as provide a means for extracting electricity from the system. Each CPV cell 12 has two electrical connections and essentially acts as a photodiode that generates electrical power when solar energy is incident upon the top surface of CPV cell 12. Use of the metal collar acting as the top surface electrical contact for CPV cell 12 eliminates the need for other means of making this electrical connection. Other means for making this CPV cell 12 top surface electrical connection previously noted include, but are not limited to: wire bonds, beam lead bonds, and flex circuits. Additionally, the metal collar may be designed as a spring to account for thermal effects.

In yet another exemplary embodiment, the surface of heat removal system 14 may be roughened or anodized to increase the adhesion strength and thermal conductivity of interface structure 16. By anodizing heat removal system 14, there is increased bonding between CPV cell 12 and heat removal system 14. In addition, the contact surface area between CPV cell 12 and heat removal system 14 may be increased by using a bonding material or thermal grease as interface structure 16.

The thermal management system thermally manages the temperature of a CPV cell by ensuring increased thermal contact and decreased thermal resistance between the CPV cell and a heat removal system. By adding an interface structure between the CPV cell and the heat removal system, the mechanical stresses on CPV cell 12 due to differences in the coefficients of thermal expansion of the layers of the solar cell system and the heat removal system are minimized. The interface structure and the heat removal system are also arranged in such a way as to ensure that the electrical contacts of the CPV cell are insulated from each other and from the thermal management system while providing sufficient thermal conductivity to remove heat from the CPV cell.

Although the present invention has been described with reference to preferred embodiments, workers skilled in the art will recognize that changes may be made in form and detail without departing from the spirit and scope of the invention. Throughout the specification and the claims, the use of the term “a” should not be interpreted to mean “only one”, but rather should be interpreted broadly as meaning “one or more.” Furthermore, the use of the term “or” should be interpreted as being inclusive unless otherwise stated.

1. A concentrated solar energy system, the system comprising:
a photovoltaic cell;
an optical concentrator configured to direct concentrated solar energy to the photovoltaic cell, thereby causing the photovoltaic cell to generate electricity and heat;
a heat removal system for removing heat from the photovoltaic cell; and
means for providing thermal contact between the photovoltaic cell and the heat removal system, wherein the means for providing thermal contact provides a thermal conductivity per unit length between the photovoltaic cell and the heat removal system of greater than about 50 kilowatts per square meter per degree Celsius.

2. The system of claim 1, wherein the means for providing thermal contact provides a thermal conductivity per unit length between the photovoltaic cell and the heat removal system of greater than about 100 kilowatts per square meter per degree Celsius.

3. The system of claim 2, wherein the means for providing thermal contact provides a thermal conductivity per unit length between the photovoltaic cell and the heat removal system of greater than about 200 kilowatts per square meter per degree Celsius.

4. The system of claim 3, wherein the means for providing thermal contact provides a thermal conductivity per unit length between the photovoltaic cell and the heat removal system of greater than about 300 kilowatts per square meter per degree Celsius.

5. The system of claim 1, wherein the optical concentrator further includes tertiary optics positioned proximate the photovoltaic cell.

6. The system of claim 1, wherein the photovoltaic cell is a concentrator photovoltaic cell.

7. The system of claim 1, wherein adjacent layers of the solar energy system are placed in contact with thermal grease having aluminum nitride microspheres under hydraulic pressure.

8. The system of claim 7, and further comprising an optical fluid positioned above the photovoltaic cell for providing passage of the concentrated solar energy through the optical fluid to the photovoltaic cell, wherein the hydraulic pressure on the thermal grease is provided through the optical fluid.

9. The system of claim 1, wherein the means of providing thermal contact is a dovetail connection arrangement connectable to a heat sink of the solar energy system.

10. The system of claim 1, wherein the means of providing thermal contact is a layer selected from the group consisting of: a thin layer of dielectric material on the heat removal system and an aluminum nitride substrate attached to the heat removal system.

11. The system of claim 10, wherein the thin layer of dielectric material is selected from the group consisting of: polyimide, polybenzyl imidizole, and mixtures thereof.

12. The system of claim 10, and further comprising a patterned metal deposited on the thin layer of dielectric material, wherein the patterned metal is selected from the group consisting of: direct bond copper, thick film metal, and thin film metal.

13. The system of claim 10, wherein the thin layer of dielectric material is aluminum phosphate.

14. The system of claim 1, wherein the means of providing thermal contact is a die attach material having anisotropic stiffness in at least one direction.

15. The system of claim 1, wherein the means of providing thermal contact is a heat spreader.

16. The system of claim 1, wherein the means of providing thermal contact maintains approximately equal coefficients of thermal expansion between adjacent layers of the concentrated solar energy system.

17. The system of claim 16, wherein the means of providing thermal contact maintains approximately equal coefficients of thermal expansion between the photovoltaic cell and the optical concentrator.

18. A solar cell system comprising:
a solar cell that generates electrical energy and heat;
a heat removal system for dissipating the heat from the solar cell; and
an interface structure positioned between the solar cell and the heat removal system for transferring the heat from the solar cell to the heat removal system;
wherein at least 75 percent of the heat generated by the solar cell is transferred to the heat removal system.

19. The system of claim 18, wherein at least 90 percent of the heat generated by the solar cell is transferred to the heat removal system.

20. The system of claim 18, wherein heat transfer by the interface structure provides a temperature difference between the solar cell and the heat removal system of less than about 2 degrees Celsius.

21. The system of claim 18, wherein the interface structure maintains approximately equal coefficients of thermal expansion between the solar cell and the heat removal system.

22. The system of claim 18, wherein the interface structure comprises a thin dielectric layer formed on the heat removal system.

23. The system of claim 18, wherein the interface structure is formed of a thermally conductive material.

24. The system of claim 18, wherein the interface structure provides electrical connection for the solar cell.

25. The system of claim 18, wherein the interface structure comprises thermal grease filled with an electrically insulating high thermal conductivity material.

26. A method of removing heat from a photovoltaic cell comprising:
positioning a heat removal system proximate to the photovoltaic cell;
providing thermal contact between the photovolatic cell and the heat removal system, wherein the thermal contact results in at least 75% of the heat from the photovoltaic cell being transferred to the heat removal system.

27. The method of claim 26, wherein the providing thermal contact comprises transferring at least 90% of the heat from the photovoltaic cell to the heat removal system.

28. The method of claim 26, wherein the providing thermal contact comprises providing a thermal conductivity per unit length between the photovoltaic cell and the heat removal system of greater than about 50 kilowatts per square meter per degree Celsius.

29. The method of claim 28, wherein the providing thermal contact comprises providing a thermal conductivity per unit length between the photovoltaic cell and the heat removal system of greater than about 300 kilowatts per square meter per degree Celsius.

30. The method of claim 26, wherein the providing thermal contact comprises positioning an interface structure between the photovoltaic cell and the heat removal system.

31. The method of claim 26, wherein the providing thermal contact comprises maintaining a temperature difference between the photovoltaic cell and the heat removal system of less than about 2 degrees Celsius.

32. The method of claim 26, wherein the providing thermal contact comprises maintaining approximately equal coefficients of thermal expansion between the photovoltaic cell and the heat removal system.
